(19) United States
(12) Patent Application Publication
(10) Pub. No.: US 2022/0084026 A1
(43) Pub. Date: Mar. 17, 2022

(54) SECURE TRANSACTIONS

(71) Applicant: Hewlett-Packard Development Company, L.P., Spring, TX (US)

(72) Inventors: Helen Balinsky, Bristol (GB); Josep Abad Peiro, Sant Cugat del Valles (ES)

(73) Assignee: Hewlett-Packard Development Company, L.P., Spring, TX (US)

(21) Appl. No.: 17/420,061

(22) PCT Filed: Jan. 9, 2019
(86) PCT No.: PCT/US2019/012911

§ 371 Date: Jun. 30, 2021

(51) Int. Cl. G06Q 20/40

(52) U.S. Cl. CPC G06Q 20/401

(57) ABSTRACT

In an example there is provided a method to: communicate an offer of an item for sale to an entity based on an entity identifier, generate transaction data specifying the offer of the item for sale to the entity, the transaction data comprising at least the entity identifier, the item offered for sale, and a purchase condition for the item; and store the transaction data in a secure ledger.

### BACKGROUND

Electronic commerce is an enormous part of the modern commercial landscape. Online, users are frequently targeted with adverts to buy certain products. Personalised adverts and purchase recommendations can help consumers make choices and increase profitability for businesses since recommendations are tailored to individual consumers' needs. Furthermore, personalised purchase recommendations reduce the time that is wasted browsing unwanted items. This may enhance the customer experience.

### BRIEF DESCRIPTION OF THE DRAWINGS

Various features of certain examples will be apparent from the detailed description which follows, taken in conjunction with the accompanying drawings, which together illustrate, by way of example, a number of features, wherein:

FIG. 1 shows an apparatus for managing a transaction according to an example.

FIG. 2 shows a block diagram of a method for storing transaction information to a secure ledger according to an example.

FIG. 3 shows a processor associated with a memory and comprising instructions for performing managing a transaction according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

Users of the internet will be familiar with targeted advertising. Targeted advertising is a hugely profitable activity and is ubiquitous on the internet. It is in the interest of the user and the advertiser to ensure that the adverts displayed to a user are interesting and relevant for that user. This has not always been the case. In the early days of the internet, adverts and advertising in general was considered more of a nuisance to users.

However, since the advent of machine learning algorithms, the online shopping experience for consumers has vastly improved. For example, e-commerce recommendation systems automatically generate highly targeted recommendations which users may find useful.

Machine learning algorithms evaluate historic user data or what is also sometimes called training data, to develop a classification algorithm, also known simply as a classifier. The classifier can be used on new observations to identify which class those observations belong in. In particular, a classifier takes the new point and evaluates the new data associated to that point to determine the relevant classes.

In the context of e-commerce, a user may have made a number of historic product purchases which places them in particular subclasses for new product recommendations. This data can be used as training data to develop a classifier. The classifier can be used to place the user in classes for future product recommendations.

Machine learning algorithms are not deterministic programs. The output of the algorithm may depend on the most up-to-date data and run-time factors. For example, in the context of e-commerce environments, a product recommendation that is output by a machine learning algorithm at a later stage might be different from the one recommended at an earlier point in time to a user. This is because the most up-to-date data which is input into the machine learning algorithm can result in a change to the classifier which was used to generate the original product recommendation. This subsequent recommendation may be more or less appealing to a customer. Somewhat frustratingly for the customer, this can result in recommendations which were previously of interest to the customer being lost.

In certain cases, therefore, it may be desirable to lock in a particular product recommendation. The methods and systems described herein can be used to achieve this. This may include turning any given product recommendation into a sale offer. In certain cases, the sale offer could be made valid for a period of time, turning a recommendation into a trackable and verifiable transaction. This allows a customer to carry on browsing, compare prices and evaluate other factors which influence final purchase decision without losing an offer of an earlier recommendation.

In particular, the methods and systems described herein propose a mechanism for securing an automatic recommendation, turning it into a digital contract, verifiable and enforceable commitment. This includes converting the recommendation from a suggestion such as from a targeted advert into a business proposition in the form of a fully-fledged transaction. This is achieved using secure ledger technology.

Secure ledgers can be used in a diverse range of contexts to provide guarantees that certain processes have properly been executed and that tasks have been carried out according to a well-defined process. Secure ledgers implement cryptographic hash functions to ensure the integrity of a process or data represented in the ledger.

A secure ledger may be implemented as follows: the output of a record or block of an earlier transaction in the ledger is hashed and is used as an input to the next block in a chain. Further data may be input into the next block such a record that a further transaction has occurred. This creates a secure-by-design process where the integrity of any point of the chain can be verified by recomputing hash values on inputs and checking the recomputed hash values against the ledger. In certain examples it is sufficient to check the final output against the last recorded item on the ledger based on the inputs.

Another feature of a secure ledger is that the ledger may be stored in a decentralized fashion. For example, the ledger can be stored across a peer-to-peer network where nodes hold their own copy of the ledger and can collectively verify the authenticity of alleged transactions by recomputing ledger data.

Using secure ledgers, it is possible to execute whole protocols and maintain a verifiable record of each step of the protocol. For example, “smart contracts” allow the digital facilitation, verification and/or enforcement of the negotiation or performance of a contract. Smart contracts allow the performance of credible transactions without third parties such as legal entities being involved. Decentralized cryptocurrencies such as Bitcoin may be considered a form of smart contract between participants. Bitcoin and other cryptocurrencies implement a secure ledger which provides a secure and verifiable transaction history which may be verified by anyone at a later point in time.

Ledger technology digitizes and simplifies many processes which would previously use trusted third-party verification to perform securely. Secure ledgers provide a higher degree of certainty for participants and provide greater security over trusted third-party models.

The methods and systems described herein implement a secure ledger to record proposals or offers associated to recommendations. A targeted consumer is identified by his or her signature-based identity. A transaction is generated which specifies an item and a number of attributes associated to the item which may include the price and, in certain cases, a time period in which the offer is valid. The transaction may be certified by the system which generated the recommendation in the first place.

The transaction is recorded on the secure ledger and the consumer may execute at any time, the offer within its validity by creating their own “purchase request” transaction. The secure ledger provides a way to ascertain the validity of the offer to the consumer, and the requested purchase will be accepted or declined based on the content of the secure ledger.

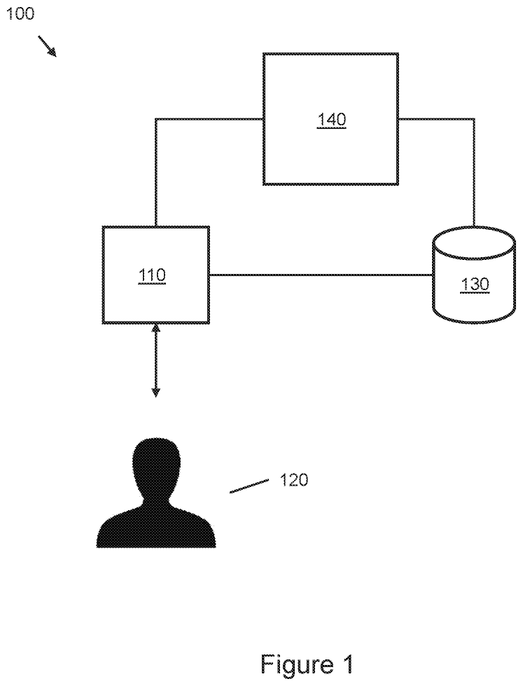

FIG. 1 shows an apparatus 100 for recording a transaction to a secure ledger according to an example. The apparatus 100 shown in FIG. 1 can be implemented in software, hardware, or a mix of both software and hardware. The apparatus 100 comprises a transaction management module 110. The transaction management module 110 may be implemented in the “cloud” over a network such as the internet. The transaction management module 110 may be implemented in hardware or as software implemented on a computer readable medium. An entity 120 is in communication with the transaction management module 110. In examples the entity 120 may be a user, group of users, organisation or department within an organisation, for example. According to examples, if the entity 120 communicates over a network interface with the transaction management module. Such a network interface may be implemented in hardware on a computing device or as software implemented on a computer readable medium.

The transaction management module 110 may be implemented as a backend service, in conjunction with a frontend client-facing interface such as a web browser or local application running on the client device. Such an interface may be a graphical user interface which displays purchasable items to the entity 120. The transaction management module 110 is arranged to communicate an offer of an item for sale to entities based on entity identifiers. According to examples, the entity identifier may be used to target particular items for sale to the entity.

In contrast making recommendations on a purely non-obligatory advisory basis, the transaction management module 110 is arranged to initiate a transaction from transaction data which is then recorded in a secure ledger. To this end, the transaction management module 110 is communicatively coupled to a secure ledger 130. According to examples described herein a “secure ledger” is a data structure comprising a sequence of blocks of data. Each block references and is derived from at least one of the previous blocks in the sequence. In addition, each block may comprise additional data corresponding to additional inputs. The secure ledger 130 may be implemented in software and stored in data storage by a server. In some cases, the transaction management module 110 and secure ledger 130 are implemented on the same physical server. In other cases, they are implemented at different physical locations.

According to examples described herein, transaction data comprising at least an entity identifier for the entity 120, the items offered for sale, and purchase condition for the items is recorded in the secure ledger 130. In examples, the purchase condition may be a purchase price. In other cases, the purchase condition may be a loan period, for example. Recording data to the secure ledger 130 comprises computing an initial entry to the secure ledger as a function of the transaction data of an initial transaction. An initial transaction may be used to form the first block in a chain of blocks that comprises the secure ledger 130.

According to examples, computing a subsequent entry to the secure ledger 130, is performed by computing the next block in the secure ledger as a function of the previous entry on the secure ledger 130 together with the transaction data of the latest transaction. According to examples described herein a cryptographically secure hash function may be used to securely record data into the secure ledger 120. In certain cases, a public key infrastructure is implemented between entities and the transaction management module 110. In this case, the entity 120 may be identifiable by a public key. The transaction data may specify a number of attributes of items.

In the example shown in FIG. 1, the transaction management module 110 is communicatively coupled to a personalized offer creation module 140. The personalized offer creation module 140 is arranged to access historic transaction data from the secure ledger 130. According to examples, the personalized offer creation module 140 is arranged to generate personalized offer data relating to the purchase of one or more items based on at least the historic transaction data recorded in the secure ledger 130. In examples, the personalized offer may be based on other known information, for example, customer specific or demographic information. In certain examples, this is implemented using one or more machine learning algorithms. The personalized offer creation module 140 can use the data stored in the secure ledger 130 and, in certain cases other data to construct a classifier. The personalized offer creation module 140 is arranged to communicate the personalized offer data to the transaction management module 110.

According to examples described herein the transaction management module 110 is arranged to receive a purchase request in the form of purchase request data from the entity 120. The purchase request data may include a request to purchase an item that has been offered to the entity 120, possibly by the personalized offer creation module 140. The purchase request data further comprises a reference to a previous transaction that has been recorded in the secure ledger 130 and the request if further signed by an entity identifier of the entity 120, such as his private key corresponding to the known public key of the entity 120.

According to examples described herein, the transaction management module 110 is arranged to identify transaction data based on the reference to the previous transaction in the purchase request data and determine whether to execute a sale to the entity 120 based on the content of the secure ledger 130. In the case that the transaction data corresponds to data recorded on the secure ledger, then the purchase request will be fulfilled.

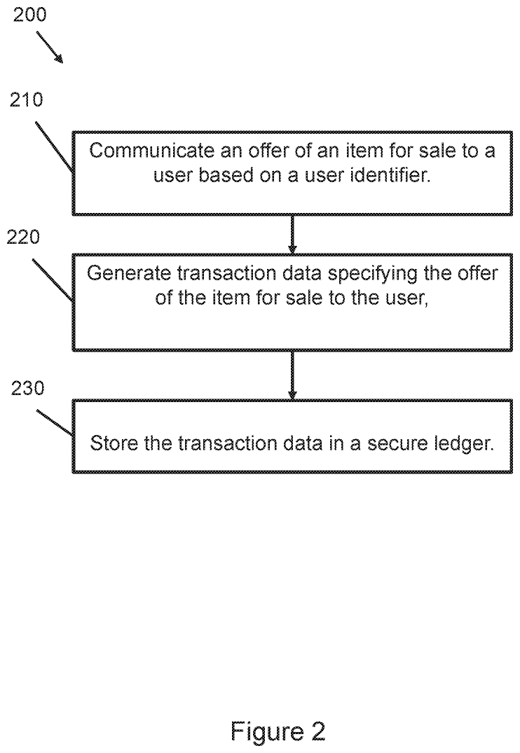

FIG. 2 shows a block diagram of a method 200 to securely execute a transaction according to an example. The method 200 may be implemented on the apparatus 100 shown in FIG. 1. At block 210 an offer of an item for sale is communicated to an entity based on an entity identifier. As previously described the identifier may be a public key of an entity. The offer may be generated from the personalized offer creation module 140 shown in FIG. 1. At block 220 transaction data specifying the offer of the item for sale to the entity is generated.

The transaction data comprises at least the entity identifier, the item offered for sale, and a purchase condition for the item. At block 230, the transaction data is stored in a secure ledger such as the secure ledger 130 shown in FIG. 1. According to examples described herein, the transaction data may be digitally signed by the personalized offer creation module 140.

According to an example, the method 200 shown in FIG. 1 further comprises receiving purchase request data from a first entity. The purchase request data comprises a request to purchase an item, a reference to an existing offer transaction, and a first entity identifier. Transaction data based on the reference to the existing offer in the purchase request data is identified and a determination of whether to execute a sale to the first entity is made based on the content of the secure ledger.

According to an example, the method 200 shown in FIG. 2 may further comprise receiving offer transfer data from the first entity. The offer transfer data comprises a request to transfer an offer to purchase an item together with a reference to the previous transaction and an entity identifier of a second entity. The method comprises identifying transaction data based on the reference to the previous transaction in the offer transfer data.

In a further example, the method 200 comprises receiving purchase request data from the second entity, the purchase request data comprising a request to purchase the item, a reference to an offer transfer, and an identifier of the second entity. The method comprises identifying transaction data based on the reference to transfer the offer and determining whether to execute a sale to the second entity based on the content of the secure ledger. In this manner, the methods described herein can be used to transfer offers of items between different users.

In certain cases, the transaction data specifies a total number of items for sale to entities. In this case, determining whether to execute a sale or not may further comprise determining whether the number of references to a previous transaction recorded on the secure ledger exceeds the total number of items for sale.

In further examples, the transaction data comprises a period of validity of the offer of the item for sale. For example, an offer of a sale may be valid for a limited period of time such as 1 month. This information may also be recorded in the secure ledger. In such a case, determining whether to execute a sale also comprises determining whether the time period in which the offer is valid has been exceeded.

The methods and systems described herein utilise secure ledger technology to provide a recommendation system in contractual and enforceable form. This includes, amongst other things, providing a managed, controlled and binding offer if sale of an item, which can be legally enforced via the secure ledger.

Furthermore, in contrast to systems, which merely provide in-the-moment recommendations of sale items which may or may not be of interest to a customer, the methods and systems described herein may provide the ability to lock in recommendations at particular time periods. Certain examples described herein guarantee that purchasers-to-be are trustworthy based on previous purchasing history via the secure ledger.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted.

Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine-readable instructions stored in a memory, or a processor operating in accordance with instructions embedded in logic circuitry.

The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

For example, the instructions may be provided on a non-transitory computer readable storage medium encoded with instructions, executable by a processor.

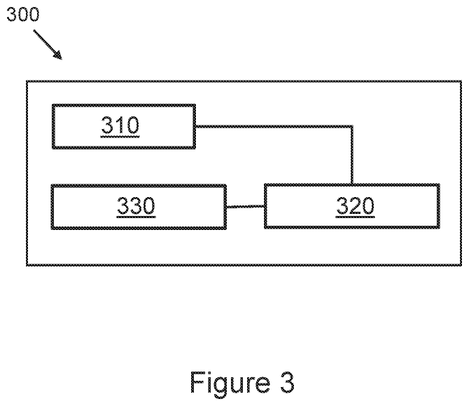

FIG. 3 shows an example of a processor 310 associated with a memory 320. The memory 320 comprises computer readable instructions 330 which are executable by the processor 310. The instructions 330 comprise instruction to, generate a sale offer of an item to an entity based on an entity identifier, the sale offer comprising the item offered and a purchase condition; compute transaction data for the sale offer to the entity; and record the transaction data in a secure ledger.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method, comprising:
communicating an offer of an item for sale to an entity based on an entity identifier;
generating transaction data specifying the offer of the item for sale to the entity, the transaction data comprising at least the entity identifier, the item offered for sale, and a purchase condition for the item; and
storing the transaction data in a secure ledger.

2. The method of claim 1, wherein the entity is a user, group of users, organisation or a department of an organisation.

3. The method of claim 1, wherein the entity identifier is a public key of the entity.

4. The of claim 1, wherein the purchase condition comprises a price and a duration in which the item may validly be purchased.

5. The method of claim 1, comprising:
receiving purchase request data from a first entity, the purchase request data comprising a request to purchase an item, a reference to an existing offer transaction, and a first entity identifier;
identifying transaction data based on the reference to the transaction in the purchase request data; and
determining whether to execute a sale to the first entity based on the content of the secure ledger.

6. The method of claim 5, wherein determining whether to execute a sale to the first entity based on the content of the secure ledger comprises:
determining that the request to purchase an item is valid;
determining that the offer transaction exists and is still valid; and
determining that that the first entity is entitled to purchase the item.

7. The method of claim 5, wherein the purchase request data is digitally signed by the entity entitled to purchase under the original transaction.

8. The method of claim 5, comprising:
receiving offer transfer data from the first entity, the offer transfer data comprising a request to transfer an offer to purchase the item, a refence to the previous transaction and an entity identifier of a second entity; and
identifying transaction data based on the reference to the previous transaction in the offer transfer data.

9. The method of claim 8, comprising:
receiving purchase request data from the second entity, the purchase request data comprising a request to purchase the item, a reference to an offer transfer, and an entity identifier of the second entity;
identifying transaction data based on the reference to transfer the offer; and
determining whether to execute a sale to the second entity based on the content of the secure ledger.

10. The method of claim 1, comprising computing an initial entry to the secure ledger as a function of the transaction data of an initial transaction.

11. The method of claim 1, wherein storing transaction data in the secure ledger comprises:
computing a subsequent entry to the secure ledger as a function of at least the previous entry on the secure ledger.

12. An apparatus comprising:
a transaction management module to:
communicate an offer items for sale to an entity based on an entity identifier; and
initiate a transaction from transaction data to offer items for sale to entities, the transaction data comprising at least the entity identifier, the items offered for sale, and a purchase condition of the item; and
a secure ledger arranged to track transactions.

13. The apparatus of claim 12, wherein the transaction management module is to:
receive purchase request data from a first entity, the purchase request data comprising a request to purchase an item, a reference to a previous transaction, and a first entity identifier;
determine transaction data based on the reference to the previous transaction in the purchase request data; and
determine if a sale is to be made to the first entity based on the content of the secure ledger.

14. The apparatus of claim 12, comprising:
a personalized offer creation module, arranged to:
access historic transaction data from the secure ledger;
generate personalized offer data to the entity relating to the purchase of items based on the historic data; and
communicate the personalized offer data to the transaction management module.

15. A non-transitory machine-readable storage medium encoded with instructions executable by a processor, to:
generate a sale offer of an item to an entity based on an entity identifier, the sale offer comprising the item offered and a purchase condition;
compute transaction data for the sale offer to the entity; and
record the transaction data in a secure ledger.
